(19) United States
(12) Patent Application Publication
(10) Pub. No.: US 2011/0253228 A1
(43) Pub. Date: Oct. 20, 2011

(54) Rotary Inflation Nozzle

(76) Inventor: Ying-Che Huang, Sioushuei Township (TW)

(21) Appl. No.: 12/980,462

(22) Filed: Dec. 29, 2010

(30) Foreign Application Priority Data
Apr. 20, 2010 (TW) 99112366

(51) Int. Cl. F16K 15/20

(52) U.S. Cl. 137/232

(57) ABSTRACT

A rotary inflation nozzle includes a block assembly seat, a housing, and a cap. A needle tube and a block member are mounted in the housing and the cap and mounted to a front end of the block assembly seat. The block assembly seat includes an end having a receiving section. The block assembly seat further includes an air passageway in communication with the receiving section. The receiving section has an inner diameter larger than that of the air passageway. A limiting section is formed on the front end of the block assembly seat and has an outer diameter larger than the block assembly seat. The needle tube includes first and second engaging ends. The first engaging end of the needle tube is received and retained in the receiving section. The block member includes a central hole. The central hole of the block member receives and is retained in place by the second engaging end of the needle tube.

### BACKGROUND OF THE INVENTION

The present invention relates to a rotary inflation nozzle and, more particularly, to a rotary inflation nozzle for an inflation pump.

FIG. 1 shows a conventional notary nozzle disclosed in U.S. Pat. No. 7,588,048 B2 (Taiwan Invention Patent No. 1307388) issued to Applicant. The inflation nozzle includes a block assembly seat 50 adapted to be connected to an outlet of an inflation pump and a housing 40 mounted around the block assembly seat 50. The block assembly seat 50 includes a compartment 51 in an end thereof and an air outlet 52 extending from the compartment 51 and in communication with the outlet of the inflation pump for guiding air for inflating operation. A block member 25 is mounted in the compartment 51 and has an insertion hole. A needle tube 24 is mounted in the insertion hole of the block member 25 and has an air outlet 243. The needle tube 24 includes a protruded edge forming a first engaging end 241 and a smaller section forming a second engaging end 242. The second engaging end 242 has a diameter smaller than that of the first engaging end 241 and corresponding to circular cross sections of a concave edge or shoulder 252 in the block member 25 so as to be limited by the position of the block member 25. The housing 40 includes a first inner thread 401 in an end thereof for thread coupling with a thread 31 at a front end of an American valve 30. Thus, the American valve 30 can be screwed into the compartment 51 and sealingly abut an end edge of the block member 25. The housing 40 has a second inner thread 402 in the other end thereof. A cap 41 includes an outer thread 411 threadedly engaged with the second inner thread 402. The cap 41 includes a through-hole 412 through which the air outlet 52 extends. A reduced section of the cap 41 abuts and positions the block assembly seat 50. The cap 41 is mounted around the block assembly seat 50.

Since the needle tube 24 and the block member 25 are separate from the block assembly seat 50, the needle tube 24 and the block member 25 mounted in the compartment 51 of the block assembly seat 50 can be replaced with ones having desired specifications responsive to differing types of American valves and Woods valves while cooperating with the sealing contact provided by the first inner thread 401 of the housing 40. Furthermore, the needle tube 24 can be made of inexpensive plastic material such that various needle tubes 24 are sufficient to inflate various valves without replacing the expensive block assembly seat 50 that is mainly made of metal. Thus, the assembly is easier while reducing the manufacturing costs.

However, the block assembly seat 50 including the compartment 51 for receiving and positioning the block member 25 and the needle tube 24 still occupies a certain space, leading to an increase in the consumption of metal material for forming the block assembly seat 50. Specifically, in order to obtain sufficient structural strength, the block assembly seat 50 is formed by deep-cutting of a solid cylinder to form the compartment 51, resulting in a waste in the material. Thus, the overall volume of the block assembly seat 50 and the amount of metal material for forming the block assembly seat 50 can be reduced if the solid portion surrounding the compartment 51 can be reduced.

### BRIEF SUMMARY OF THE INVENTION

The present invention provides a rotary inflation nozzle including a block assembly seat, a housing, and a cap. A needle tube and a block member are mounted in the housing and the cap and mounted to a front end of the block assembly seat. The block assembly seat includes an end having a receiving section. The block assembly seat further includes an air passageway in communication with the receiving section. The receiving section has an inner diameter larger than that of the air passageway. A limiting section is formed on the front end of the block assembly seat and has an outer diameter larger than the block assembly seat. The needle tube includes first and second engaging ends. The first engaging end of the needle tube is received and retained in the receiving section. The block member includes a central hole. The central hole of the block member receives and is retained in place by the second engaging end of the needle tube. Thus, the overall volume of the rotary inflation nozzle according to the present invention is reduced by reducing the overall length and by using less material. Furthermore, the block member can be retained by the needle tube so as not to be in rotational, frictional contact with the housing.

Preferably, the limiting section includes an annular groove, and an O-ring is received in the annular groove.

Preferably, the housing includes a rear end having an inner diameter covering the annular groove of the limiting section and abutting the O-ring, providing airtight effect.

Preferably, the block member and the limiting section of the block assembly seat have a first contact area therebetween. The block member and the first engaging end of the needle tube have a second contact area therebetween. The block member is in intimate contact with the limiting section and the first engaging end at the first and second contact areas. The block member is adapted to engage with a valve. A pressure generated after the valve presses against the block member causes the block member to deform and press against the first and second contact areas, providing an airtight state.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a conventional rotary inflation nozzle.

FIG. 2 shows a partial, perspective view of an inflation pump utilizing a rotary inflation nozzle according to the present invention.

FIG. 3 shows an exploded, perspective view of the rotary inflation nozzle according to the present invention.

FIG. 4 shows an exploded, cross-sectional view of the rotary inflation nozzle according to the present invention.

FIG. 5A shows a cross-sectional view of the rotary inflation nozzle according to the present invention engaged with an American valve.

FIG. 5B shows a cross-sectional view of the rotary inflation nozzle according to the present invention engaged with a Woods valve.

FIG. 6 is a view showing an example of assembly of the rotary inflation nozzle according to the present invention.

FIG. 7 is a view showing another example of assembly of the rotary inflation nozzle according to the present invention.

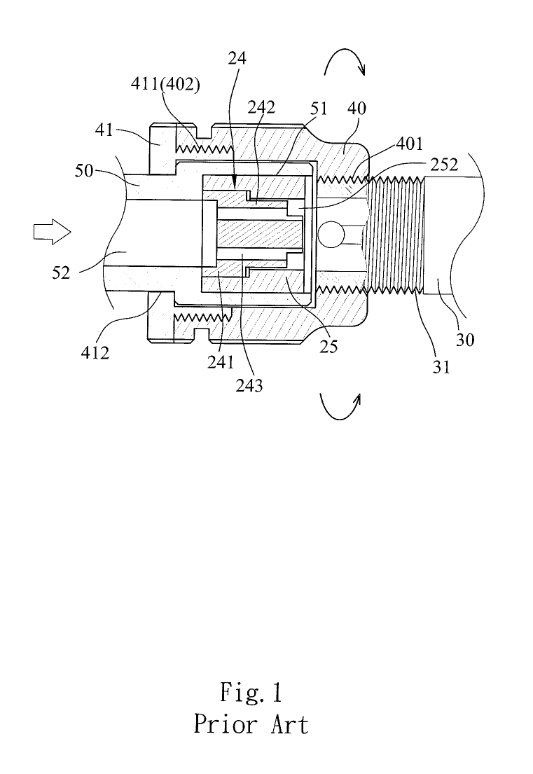

### DETAILED DESCRIPTION OF THE INVENTION

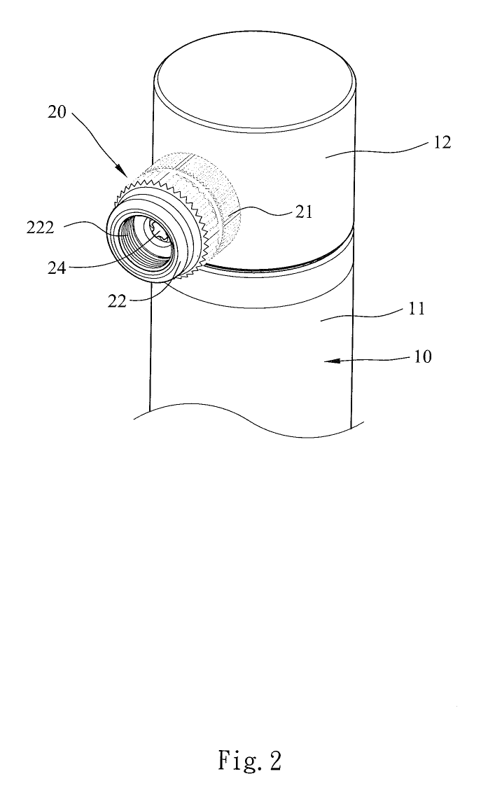

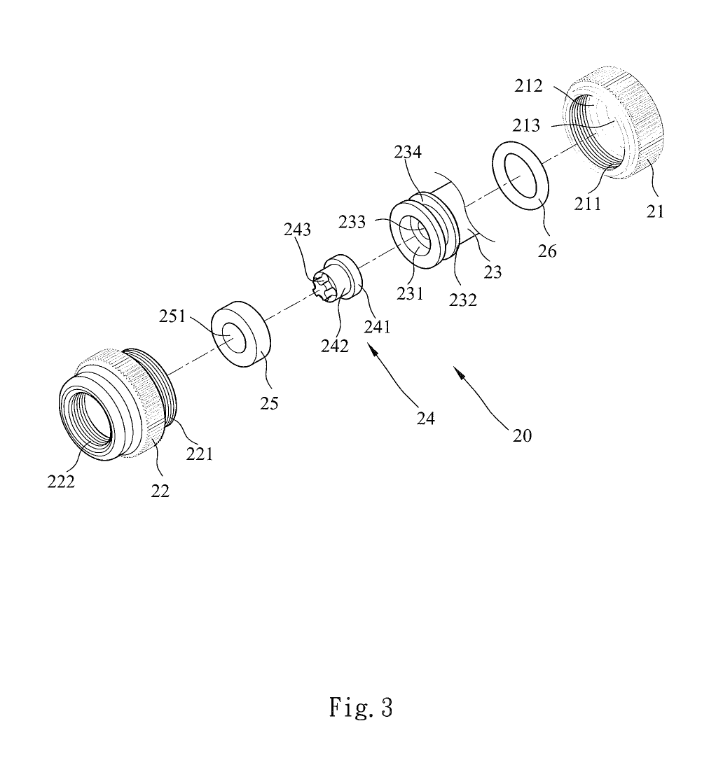

With reference to FIGS. 2-4, a rotary inflation nozzle 20 according to the present invention can reduce the length and volume occupied by the chamber 51 of the block assembly seat 50 of the conventional inflation nozzle. Thus, the chamber 51 is eliminated in the rotary inflation nozzle 20 according to the present invention. However, to retain the block member 25 and the needle tube 24 and to maintain the airtight effect by avoiding undesired friction to the block member 25 during rotation of the housing 22 after elimination of the chamber 51, the block seat assembly must be rearranged.

Specifically, the rotary inflation nozzle 20 according to the present invention includes a block assembly seat 23 connected to a gas outlet of a head 12 of an inflation pump 10. The gas outlet of the head 12 is connected to a valve in a body 11 of the inflation pump 10. The block assembly seat 23 includes a front end having a limiting section 232 having an outer diameter larger than that of the block assembly seat 23. At least one annular groove 234 is defined in an outer periphery of the limiting section 232 and receives an O-ring 26. An air passageway 233 is formed in the block assembly seat 23. A receiving section 231 is formed in a front end of the block assembly seat 23 and has an inner diameter larger than that of the air passageway 233. The receiving section 231 is formed in an end face of the front end of the block assembly seat 23.

A housing 22 and a cap 21 are mounted around the block assembly seat 23. In the preferred form shown, the housing 22 includes an outer thread 221 on a rear end thereof. The housing 22 further includes a thread 222 in a front end thereof for threadedly engaging with a thread on a front end of an American valve or a Woods valve. Thus, the inner diameter of the front end of the housing 22 having the thread 222 can be varied according to the size of the valve to be engaged.

The cap 21 includes a front end having a screw hole with an inner thread 211 for engagement with the outer thread 221 of the housing 22. A rear end of the cap 21 includes a through-hole 213 having an inner diameter slightly larger than an outer diameter of the block assembly seat 23 but smaller than the outer diameter of the limiting section 232. The cap 21 further includes a shoulder 212 formed between an inner diameter of the through-hole 213 and the screw hole having the inner thread 211. In assembly, the block assembly seat 23 is extended through the through-hole 213 until the limiting section 232 is stopped by the shoulder 212, restraining the cap 21 in a position behind the limiting section 232.

A needle tube 24 and a block member 25 are mounted to the front end of the block assembly seat 23 and mounted in a space defined by the housing 22 and the cap 21. The needle tube 24 includes a first engaging end 241 at a bottom thereof and a second engaging end 242 opposite to the first engaging end 241. In the preferred form shown, the first engaging end 241 has an outer diameter larger than that of the second engaging end 242, forming a stepped portion between the first and second engaging ends 241 and 242. The needle tube 24 includes at least one air outlet 243 extending therethrough. The block member 25 includes a central hole 251.

The first engaging end 241 of the needle tube 24 is engaged and retained in the receiving section 231 of the block assembly seat 23. The second engaging end 242 of the needle tube 24 is received in and retained in place by the central hole 251 of the block member 25. Similar to the conventional design, a front section of the second engaging end 242 presses against a valve in a tire to be inflated after thread engagement. By providing the block assembly seat 23, the housing 22, the cap 21, the needle tube 24, and the block member 25, the overall volume of the rotary inflation nozzle 20 according to the present invention is reduced after elimination of the compartment 51 in the conventional design without adverse affect to the inflating operation. The waste in material for forming the long compartment 51 by deep-cutting in the conventional design is avoided. Shallow cutting in the end face of the front end of the block assembly seat 23 is sufficient to form the receiving section 231 for receiving the first engaging end 241. Thus, a smaller housing 22 can be used, reducing the overall volume and overall length of the rotary inflation nozzle 20 and significantly reducing the material.

Furthermore, after the first engaging end 241 is received and retained in the receiving section 231, the second engaging end 242 can prevent radial movement of the block member 25. After the rotary inflation nozzle 20 is engaged with the valve of the tire and, thus, compressed, the deformed portion of the block member 25 will not be damaged due to friction between the rotating housing 22.

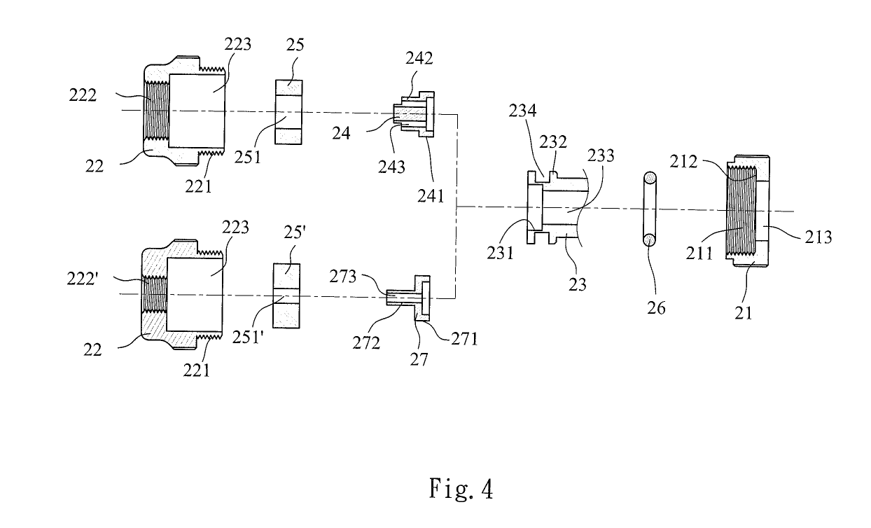

FIG. 4 also shows that the rotary inflation nozzle 20 includes a needle tube 27 for engaging with a Woods valve. The needle tube 27 includes a first engaging end 271, a second engaging end 272, and an air outlet 273. A corresponding block 25′ having a central hole 251′ is also provided. Furthermore, the housing 22 includes a screw hole having a smaller diameter and corresponding thread 222′. The differences between the screw holes merely exist in the sizes for engaging with differing valves without substantial changes in the structure.

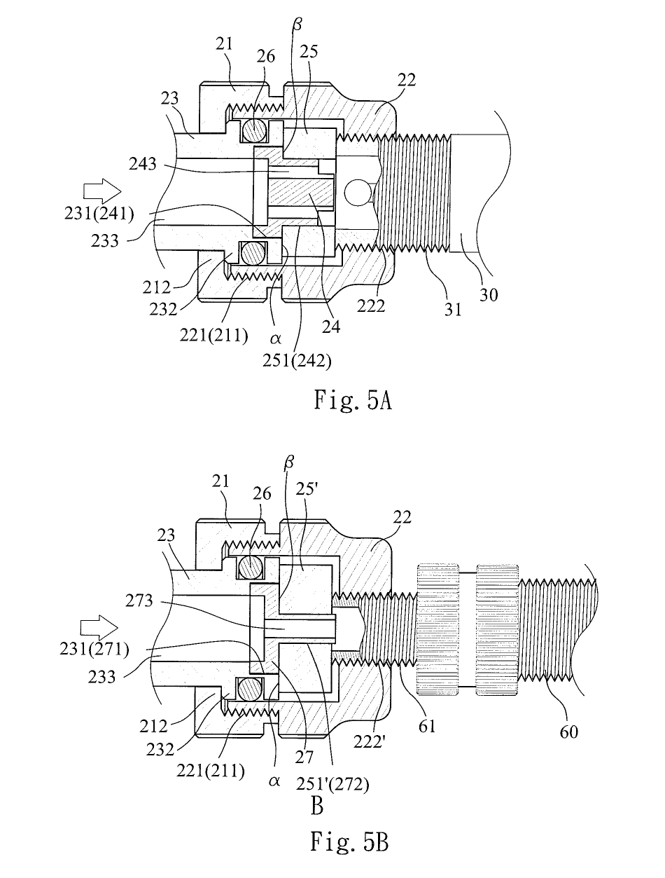

FIG. 5A shows engagement of the rotary inflation nozzle 20 with an American valve 30. The block member 25 and the limiting section 232 of the block assembly seat 23 have a contact area □ therebetween. Furthermore, the block member 25 and the first engaging end 241 of the needle tube 24 have a contact area β therebetween. The block member 25 are in intimate contact with the limiting section 232 and the first engaging end 241 at the contact areas □ and β after assembly. This provides the rotary inflation nozzle 20 with enhanced airtight effect. Thus, when the rotary inflation nozzle 20 is engaged with the thread 31 of the American valve 30 for inflating operation, the pressure generated after the American valve 30 presses against the block member 25 causes the block member 25 to deform and press against the contact areas □ and β, providing an airtight state. This assures air currents generated by the inflation pump 10 to flow through the valve of the tire into the tire without the risk of leakage at the air passageways. FIG. 5B shows engagement of the rotary inflation nozzle 20 with a Woods valve 60. To engage the Woods valve 60, the housing 22 includes a thread 222′ for engaging with a thread 61 at the front end of the Woods valve 60 having a diameter smaller than that of the American valve 30. To avoid leakage of pressure in the tire via a gap between the housing 22 and the block assembly seat 23 due to higher pressure in the tire while disengaging the front end of the American valve 30 or Woods 60 from the block member 25 or 25′ after inflating operation, the inner diameter of the rear end of the housing 22 has a length sufficient long to cover the annular groove 234 of the limiting section 232 and to press against the O-ring 26 after assembly of the housing 22 and the cap 21. This provides the interior of the rotary inflation nozzle 20 with the best airtight effect. Thus, the sealing state during inflating operation is in the best condition.

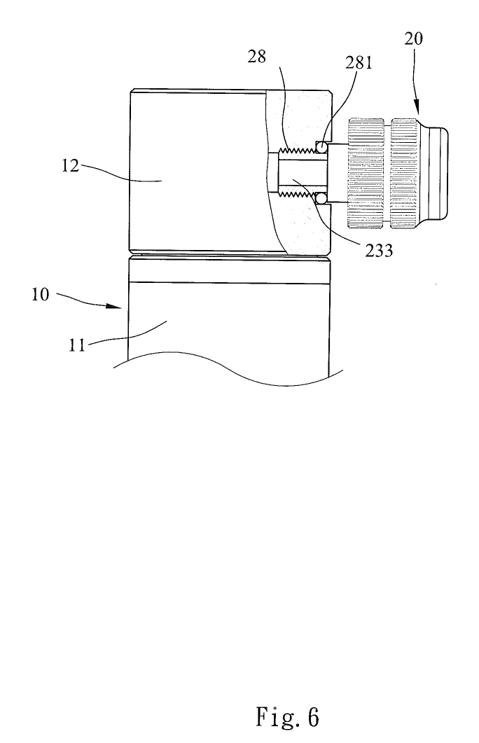

With reference to FIG. 6, the air outlet 233 of the rotary inflation nozzle 20 can further include a threaded end 28 for engaging with the gas outlet in the head 12 of the inflation pump 10. Furthermore, an O-ring 218 can be mounted in the engagement area for sealing purposes.

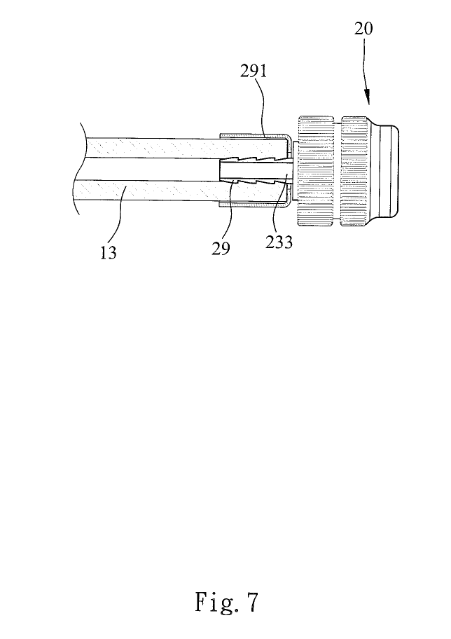

In an alternate example shown in FIG. 7, the air outlet 233 of the rotary inflation nozzle 20 can be engaged with a serrated sleeve 29 and then a hose 13. A sleeve 291 is then tightly fixed around the hose 13 by using a tool. The hose 13 is then connected to the inflation pump, providing an extension in length.

In view of the foregoing, the rotary inflation nozzle 20 according to the present invention has a reduced length and a reduced volume and uses less material while providing the same excellent airtight effect.

Although specific embodiments have been illustrated and described, numerous modifications and variations are still possible without departing from the essence of the invention. The scope of the invention is limited by the accompanying claims.

1. A rotary inflation nozzle comprising a block assembly seat, a housing, and a cap, with a needle tube and a block member mounted in the housing and the cap and mounted to a front end of the block assembly seat, characterized in that:
the block assembly seat includes an end having a receiving section, the block assembly seat further includes an air passageway in communication with the receiving section, the receiving section having an inner diameter larger than that of the air passageway, a limiting section is formed on the front end of the block assembly seat and has an outer diameter larger than the block assembly seat,
the needle tube includes first and second engaging ends, the first engaging end of the needle tube is received and retained in the receiving section,
the block member includes a central hole, the central hole of the block member receives and is retained in place by the second engaging end of the needle tube.

2. The rotary inflation nozzle as claimed in claim 1, with the limiting section including an annular groove, with the rotary inflation nozzle further comprising an O-ring received in the annular groove.

3. The rotary inflation nozzle as claimed in claim 2, with the housing including a rear end having an inner diameter covering the annular groove of the limiting section and abutting the O-ring, providing airtight effect.

4. The rotary inflation nozzle as claimed in claim 3, with the rear end of the housing including an outer thread, with the front end of the cap including an inner thread threadedly engaged with the outer thread of the housing.

5. The rotary inflation nozzle as claimed in claim 1, with the block member and the limiting section of the block assembly seat having a first contact area therebetween, with the block member and the first engaging end of the needle tube having a second contact area therebetween, with the block member being in intimate contact with the limiting section and the first engaging end at the first and second contact areas, with the block member adapted to engage with a valve, with a pressure generated after the valve presses against the block member causing the block member to deform and press against the first and second contact areas, providing an airtight state.

6. The rotary inflation nozzle as claimed in claim 1, with the first engaging end of the needle tube having an outer diameter, with the second engaging end of the needle tube having an outer diameter smaller than the outer diameter of the first engaging end, forming a stepped portion between the first and second engaging ends.
